(19) United States
(12) Patent Application Publication
(10) Pub. No.: US 2001/0029205 A1
(43) Pub. Date: Oct. 11, 2001

(54) Game program delivery system and apparatus used in same

(76) Inventors: Sagahiro Taho, Kyoto (JP); Hideya Akasaka, Kyoto (JP); Teruki Murakawa, Kyoto (JP)

Correspondence Address: NIXON & VANDERHYE P.C., 1100 North Glebe Road, 8th Floor, Arlington, VA, 22201, US

(21) Appl. No.: 09/774,661

(22) Filed: Feb. 1, 2001

Related U.S. Application Data
(60) Provisional application No. 60/206,977, filed on May 25, 2000.

(30) Foreign Application Priority Data
Mar. 30, 2000 (JP) 2000-095808
Apr. 26, 2000 (JP) 2000-125832

(51) Int. Cl. G06F 17/00

(52) U.S. Cl. 463/43

(57) ABSTRACT

A game program delivery system delivers a game program to a first game machine employing a first architecture. The hard disk included in a delivery apparatus stores a game program for a second game machine employing a second architecture, an emulator program and a game selection program. The delivery apparatus transmits the game selection program to the first game machine through the Internet to thereby execute the game selection program in the first game machine and allow a player to select a game title, and, when information representative of the selected game title is sent back from the first game machine, delivers the game program and for the selected game title and the emulator program. The first game machine thereafter executes the game program downloaded on a memory based on the emulator program.

### FIELD OF THE INVENTION

This invention generally relates to a game program delivery system and an apparatus used for same. More particularly, the invention relates to a method and apparatus for delivering to a first game machine a game program for a second game machine employing an architecture different from that of the first game machine so that a game for the second game machine may be enjoyably played on the first game machine.

### BACKGROUND AND SUMMARY OF THE INVENTION

Conventionally, game software for stand-alone and portable game machines has been sold in the state that the game program is recorded in a game information storage medium, such as a cartridge incorporating a semiconductor memory (ROM) or an optical storage medium such as CD-ROM. Such game software has been provided to the players as consumers through predetermined distribution channels. However, marketing through such distribution channels and the process of recording a game program on the game information storage medium have contributed to increases in game-software unit price and release date delays. In recent years, in order to avoid such problems, an attempt has been made for sales by delivering game programs to personal computers or cellular phones (hereinafter, merely referred to as “personal computer, etc.”) through the Internet over bidirectional information delivery mediums, such as telephone lines or cable TV lines. An attempt has been made to provide for such new sales form by adding communication access functions to the Internet on recent game machines or connecting a communication adapter by adding communication functions to older-modeled game machines.

For example, the delivery system for delivering a game program to a personal computer, etc. is structured by a server unit to deliver game programs to a personal computer, etc. The server unit stores game programs of various kinds for the personal computer, etc. The personal computer, etc. is installed with software for browsing home pages. The user of a personal computer, etc. accesses the server unit through the Internet via the browser and downloads a desired game program from the server unit However, portable and stand-alone game machines at present do not include such delivery systems as those associated with the personal computers, etc. Such a delivery system for a personal computer, etc., even if introduced onto the game machine, cannot typically be effectively utilized because most personal computers and cellular phones adopt a common architecture (or referred also called “platform”), and, if the programs utilizable for the architecture are prepared on the server-unit side, most are allowed to be delivered with desired game programs. However, portable and stand-alone game machines generally employee different architectures in new-and-old generation models, superior-and-inferior models and manufacturers, and hence cannot utilize a game program for another model. Meanwhile, game machines capable of being delivered with game programs via the Internet are limited to those of recent vintage and models added with special purpose communication adapters. Accordingly, there is a problem that less than a desired number of game programs can be delivered via the Internet. Conventionally, systems for delivering game programs have been less useful due to the above problems.

Therefore, it is a feature of the exemplary embodiments of the present invention to provide a novel game program delivery system and apparatus used for same.

Another feature of the exemplary embodiments is to provide a game program delivery system and an apparatus using same which can deliver an increased number of game programs by making a game program for another game machine model executable on a game machine capable of receiving game programs through bidirectional information delivery mediums.

A game program delivery system according to the exemplary embodiments is a game program delivery system (game program delivery system 10 as shown hereinafter) for delivering a game program from a game program delivery apparatus (game program delivery apparatus 30) to a first game machine employing a first architecture (video game machine 20) through a bidirectional information delivery medium (communication line 70). The game program delivery apparatus is provided with program storing means (hard disk 33) and delivery processing means (CPU 31, router 36, etc.). The program storing means stores at least a game program for the second game machine employing a second architecture different from that of the first game machine, at least one emulator program to enable the game program for the second game machine to be executed on the first game machine by emulating the second game machine, and a game selection program to display a game title of the game program on a display screen of the first game machine for selection by a player. The delivery processing means transmits the game selection program to the first game machine through the bidirectional information delivery medium so that the game selection program can be executed on the first game machine to allow for selecting a game title, and for delivering an emulator program together with the game program of the game title to execute the game program on the first game machine when the information indicative of the selected game title is sent-back. The first game machine is provided with processing means (CPU 21, GPU 22, etc.) to execute the game selection program sent through the bidirectional information delivery medium and display a game title on a display screen, select means (CPU 21, controller 40) to select a game title being displayed on the display screen, and delivery-data storing means (work RAM 25, memory card 60) to store the data delivered from the game program delivery apparatus. That is, the game program delivery system allows the processing means of the first game machine to execute a game program based on the emulator program delivered from the game program delivery apparatus, thereby making it possible to play a game in accordance with the game program for the second game machine on the first game machine.

In an exemplary embodiment, the program storing means includes a plurality of game programs for the second game machine having at least two kinds of architectures different from that of the first game machine and at least two emulator programs to emulate the second game machine having at least two kinds of architectures. According to the embodiment, the game program delivery apparatus delivers to the first game machine a particular game program for the second game machine and an emulator program in kind for executing that game program when that game program is selected on the first game machine. This enables the first game machine to play the game for the second game machine selected by the player based on the emulator program.

Furthermore, the game selection program includes a program for a player to provisionally select in order to grasp the outline of a desired game title, and a program to finally or formally select a desired game title to be delivered to the first game machine. The program storing means furthermore stores a preparatory program which, when a desired game title is provisionally selected by the player, displays, on the first-game-machine display screen, preparatory game information representative of at least a portion of the outline of a game to be offered by a game program of that game title. The delivery processing means, when a desired game title is provisionally selected by the player and the information representative of the selected game title is sent back, delivers a preparatory program to the first game machine. Also, the delivery processing means, when a desired game title is finally selected by the player and the information representative of the selected game title is sent back, delivers a game program of that game title together with an emulator program for executing the game program on the first game machine to the first game machine. Due to this, when provisional selection is made on the first game machine, the outline of a game title provisionally selected is output to the first game machine. When final selection is made, a game for the second game machine selected based on the emulator program is made possible to play.

The preparatory program may be a program to demonstrate a game outline by animation, a program to display a game outline by still images, a program to display comment texts explaining a game outline with text or a program using sound-output to audibly explain, for example, a game outline.

The game program delivery apparatus according to the exemplary embodiments is a game program delivery apparatus for delivering a game program through a bidirectional information delivery medium to the first game machine employing a first architecture. The game program delivery apparatus is provided with program storing means and delivery program means. The program storing means stores at least a game program for the second game machine employing a second architecture different from that of the first game machine, at least one emulator program for executing a game program for the second game machine on the first game machine by emulating the second game machine, and a game selection program for the player to select a game title of each game program displayed on the first-game-machine display screen. The delivery processing means transmits the game selection program through the bidirectional information delivery medium to the first game machine. Due to this, the game selection program is executed on the first game machine to allow for selection of a game title. The delivery processing means delivers together with a game program an emulator program for permitting the game program to be executed on the first game machine when the information representative of the selected game title is sent back through the bidirectional information delivery medium.

In accordance with the exemplary embodiments, by executing the game selection program on the first game machine, the player is allowed to select a game title for the second game machine displayed on the first game machine. The delivery processing means delivers the game program for the second game machine employing the selected second architecture together with the emulation program for permitting the game program to be executed on the first game machine to the first game machine employing the first architecture, thereby making possible to execute the game program for the second game machine on the first game machine. That is, the player satisfactorily selects a game title because the player does not select the emulator program corresponding to the game program, the game for the second game machine can be offered on the first game machine without the necessity of such troublesome operation as making the player conscious of the game program as for the second game machine. Also, because it is possible to deliver increased kinds of game-machine game programs to a single-kind of game machine, unique effects are provided including enhancing utility value of the system for delivering game programs. Particularly, delivering a game program for an older model through the bidirectional information medium and making executable the game program on a newer model provides an effect of offering a player the game program at a low price. Also, a game software maker can advantageously further profit from older game programs without consuming development costs for new games.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a game program delivery system of one embodiment of this invention;

FIG. 2 is a block diagram showing a game program delivery apparatus;

FIG. 3 is an illustrative view showing storage data on a hard disk of the delivery apparatus;

FIG. 4 is an illustrative view showing in detail the storage data;

FIG. 5 is an illustrative view showing one example of an emulator program;

FIG. 6 is a main flowchart showing operation of the game program delivery system;

FIG. 7 is an illustrative view showing one display form on a display screen of this embodiment;

FIG. 8 is an illustrative view showing a hierarchical structure of hardware, operating system and various programs;

FIG. 9 is a flowchart showing operation of the emulator program;

FIG. 10 is an illustrative view showing an interior of a work RAM;

FIG. 11 is an illustrative view showing storage data on a hard disk according to a second embodiment;

FIG. 12 is an illustrative view showing list data corresponding to the emulator;

FIG. 13 is a flowchart showing in detail step S5 according to the second embodiment;

FIG. 14 is an illustrative view showing storage data on a hard disk according to a third embodiment;

FIG. 15 is an illustrative view showing list data of demonstration programs;

FIG. 16 is a flowchart showing operation of a game program delivery system according to the third embodiment;

FIG. 17 is an illustrative view showing one display form on a display screen according to the third embodiment; and

FIG. 18 is a flowchart for explaining the principle of processing by a conventional CPU and GPU.

### DETAILED DESCRIPTION OF THE PREFERRED EMBODIMENTS

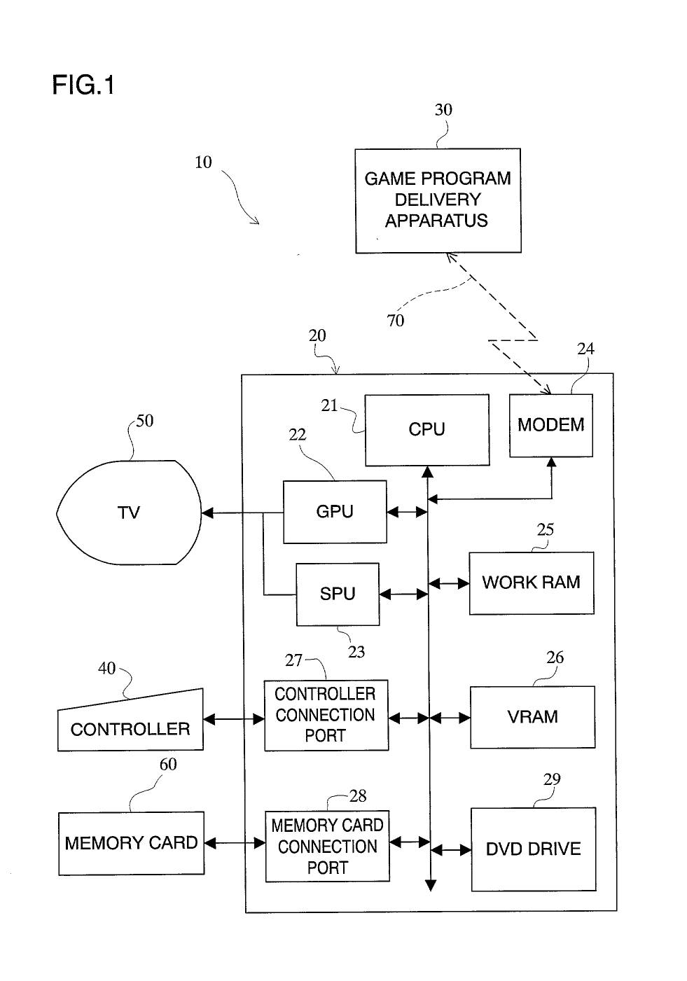

FIG. 1 is a general block diagram showing an overall game program delivery system in accordance with one exemplary embodiment of this invention. In FIG. 1, a game program delivery system 10 includes a game machine 20 as one example of new-type or superior-model first game machine (hereinafter merely referred to as “game machine 20”), a game program delivery apparatus 30 storing, for delivery, a game program for an older-type model or inferior model (hereinafter merely referred to as “delivery apparatus 30”), and a communication link 70 as one example of a bidirectional information delivery medium to be used in conjunction with the Internet for coupling information between the game machine 20 and the delivery apparatus 30.

The game machine 20 includes an associated controller as an example of operation means to move game characters (also called objects) or a cursor, a home-use TV receiver (hereinafter abbreviated as “TV”) 50 as an example of a display device to display game images, and a memory card 60 coupled in a detachable manner.

The game machine 20 includes various electronic components, such as a CPU 21 (central processing unit). The CPU 21 operates in association with a GPU (graphics processing unit) 22 through buses, and with an SPU (sound processing unit) 23, a MODEM 24, a work RAM (working memory) 25, a VRAM (video memory) 26, a controller connection port 27, a memory card connection port 28 and a DVD drive 29. The GPU 23 and SPU 24 are connected with the TV 50. The MODEM 24 is connected with a communication line 70, such as a telephone line utilized for the Internet or a cable TV line. The controller connection port 27 is connected with the controller 40, such as a joystick or control pad. To the memory card connection port 28 is removably connected the memory card 60 to store, for example, backup data, game progress data or other data/programs as required. In the DVD drive 29, a game information storage medium is inserted, such as a DVD-ROM not shown, storing a game program for the this game machine.

Specifically, the CPU 21 processes instructions of a first kind of architecture, which controls or manages the game-system overall upon startup based on an operation program stored in a program ROM (not shown) incorporated in the game machine 20. For example, CPU 21, when a DVD-ROM or the like is inserted in the DVD drive 29, processes instructions for a game based on a game program read out of the DVD-ROM. On the other hand, when a game program is delivered through the Internet 70 from the delivery apparatus 30, the CPU 21 processes based on the downloaded game program. Besides this, the CPU 21 processes instructions other than image processing instructions, e.g., read control of DVD record data, communication control to communicably access the delivery apparatus 30 through the Internet by the MODEM 24, write or read control of the work RAM 25 or VRAM 26, read-in control of input data by the controller 40, control of the GPU 23, control of the SPU 24, various operation processing for game processing and so on. Also, the CPU 21 receives an input signal from the controller 40 through the controller-connection port 27 and makes processing to change a game image according to the input signal.

The GPU 23 performs processing for image display, such as geometry operation processing and rendering process, according to instructions from the CPU 21. The SPU 24 performs processing for producing/outputting sound signals to produce sound through a speaker (not shown) of the TV 50. The work RAM 25 operates to store results of operations of the CPU 21 and program data (a game program for the first game machine or game program for the second game machine and an emulator). The VRAM 26 operates to temporarily store display data to constitute a game image (color data on the pixel basis), which is read-or-write controlled by the GPU 23). The memory card 60 incorporates a writable and readable semiconductor memory such as an SRAM or a flash memory, to store a game program delivered through the Internet utilizing the communication line 70 or game-progress backup data.

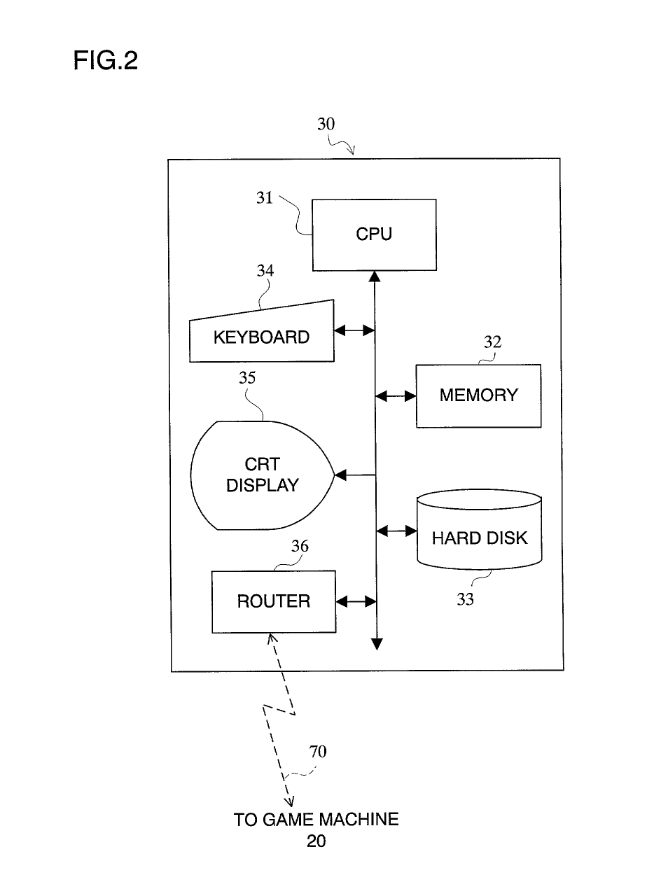

FIG. 2 is a block diagram of the game program delivery apparatus. In FIG. 2, the delivery apparatus 30 is a computer including a CPU 31 or the like and functions as so-called a server unit for accessing the Internet. Specifically, the CPU 31 is connected through buses to a memory 32, a hard disk 33, a keyboard 33, a CRT display 35 and a router 36.

The CPU 31 operates to control or manage the overall apparatus based on a main program (including various programs such as an operating system program, a device driver and communication processing program) stored on the hard disk 33. Particularly, in this embodiment, the CPU 31 performs processing related to transmission of a game program and emulator program to the game machine 20 through the Internet utilizing the communication link 70. The other processes of the CPU 31 and the functions of the memory 32, hard disk 33, keyboard 34, CRT display 35 and router 36 include conventional server unit or personal computer functions as will be appreciated by those skilled in the art.

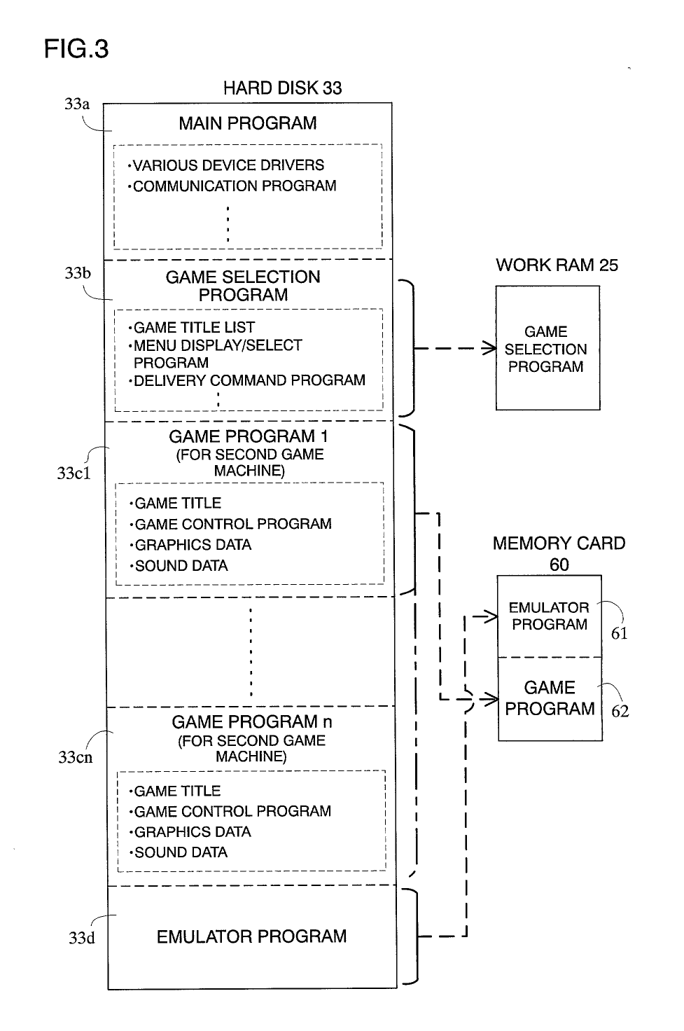

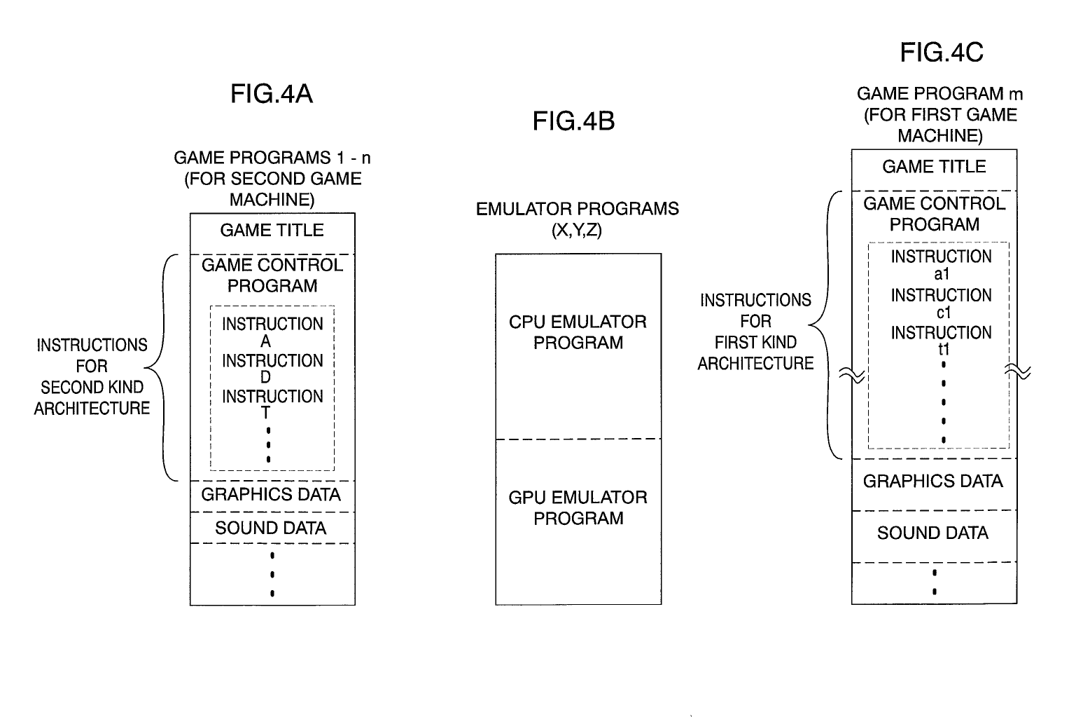

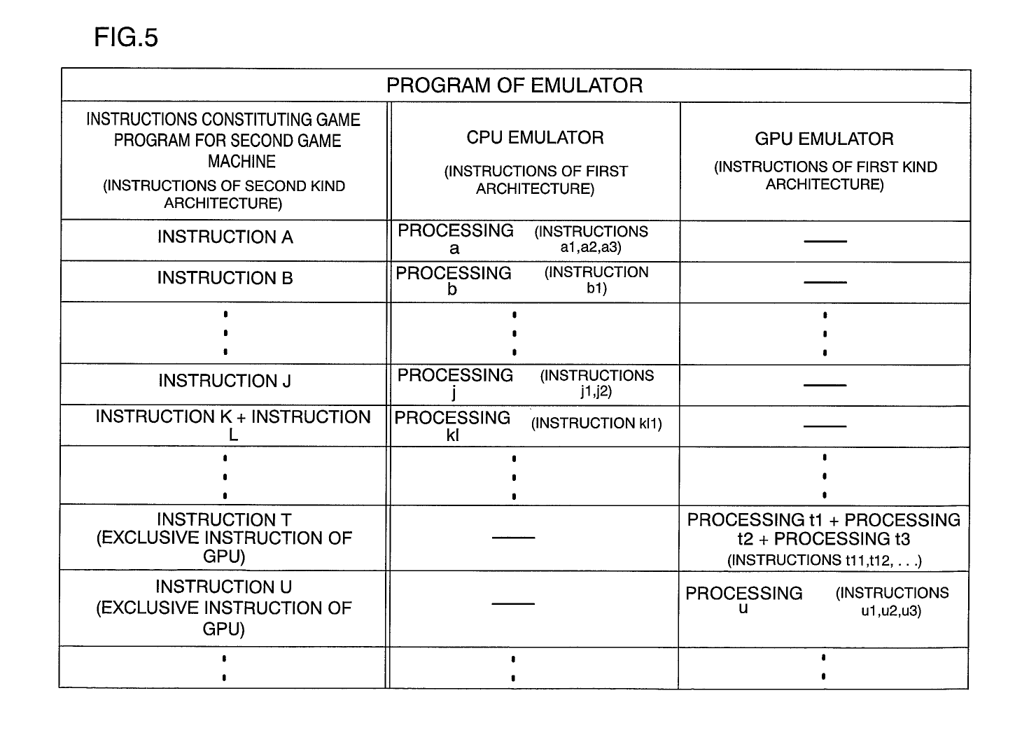

FIG. 3 is a figure illustrating storage data on the hard disk 33. FIG. 4 is a more detailed showing of the storage data, and FIG. 5 is a figure illustratively showing an example of an emulator program.

Next, an explanation follows of a game selection program, various game programs and an emulator program stored on hard disk 33, with reference to FIG. 3 to FIG. 5.

As shown in FIG. 3, the hard disk 33 includes storage areas 33a-33d. The storage areas 33a-33d store various programs. The storage area 33a stores a main program to be executed by the CPU 31 of the delivery apparatus 30. The main program is configured by instructions interpretable by the CPU 31, and includes various device drivers, an operating system program, a communication program and so on.

The storage area 33b stores a game selection program to be executed by the CPU 21 of the game machine 20. The game selection program is configured by instructions interpretable by the CPU 21, and includes a game title list for game programs 1-n, a menu display program for game titles stored or the like and a delivery start program, including as required emulator-related information such as the kind or necessity or not of emulator programs to be supplied for each game program.

The storage areas 33c1-33cn store game programs 1-n to be executed by the CPU of the second game machine (not shown; older game machine or inferior-model game machine) employing a second architecture different from that of the game machine 20. The game programs 1-n are configured, as shown in FIG. 4(a), by instructions interpretable (or processable) by the CPU of the older-type game machine, which includes game titles, game control programs, data for image-displaying (and/or image processing programs) and sound data (or sound programs) for sound processing.

In the exemplary embodiment, a plurality of second-game-machine game programs are stored in the storage area 33c, but it may be considered that only one game program is stored in the storage area 33c and that only one game program can be delivered.

The storage area 33d stores an emulator program executed by the CPU 21 of the game machine 20. The emulator program includes instructions interpretable by the CPU 21, and includes a program by which the game program for the older type game machine can be executed by emulating the older-type game machine in the game machine 20. As shown in FIG. 4(b), the emulator program of this embodiment includes a CPU emulator program which mainly emulates the CPU of the older-type game machine and a GPU emulator program which mainly emulates the GPU of the older-type game machine. This emulator program, although hereafter described, is to be realized, for example, by an instruction-word conversion table, etc. to convert an instruction for the second game machine into an instruction for the first game machine. Consequently, the instructions, e.g. A, D, T . . . , included in the game control program are instructions not to be directly interpretable by the CPU 21 (and/or GPU 22). These, after converted by use of the emulator program, are first given as instructions to be processed by the CPU 21.

As shown in FIG. 5, an emulation program stores a plurality of instructions for previous conversion and the corresponding instructions of after conversion such that, where receiving an instruction (A, B, . . . , J or K+L) constituting a game program for the second game machine, the same is converted into an instruction for the processing (a, b, . . . , j or k1) corresponding to that instruction to be executed by the CPU 21. Each time an instruction for the second game machine is given, the instruction is converted into an instruction for the CPU 21 corresponding to the received instruction and then supplied to the CPU 21, thereby emulating the instruction. Specifically, when an instruction A for the second-game-machine game program is provided, it is converted into an instruction suited for the second-game-machine game program architecture corresponding to the instruction A, thereby carrying out processing “a” corresponding to that instruction. The processing “a” may be configured by a plurality of instructions a1-a3, e.g., due to the architecture of the first game machine 20. Also, where the instruction due to the second-game-machine game program is an instruction exclusive for graphics processing (e.g. T, U), the graphics processing emulator converts it into an instruction suited for the GPU 22 architecture, according to which a processing (t1+t2+t3, etc.) is to be carried out. The detail of the processing will be described hereafter.

The above-described game selection program, game programs 1-n, and emulator program are transmitted to the game machine 20 from the router 36 or the delivery apparatus 30 via the Internet utilizing the communication line 70, and then, processed on the game machine 20.

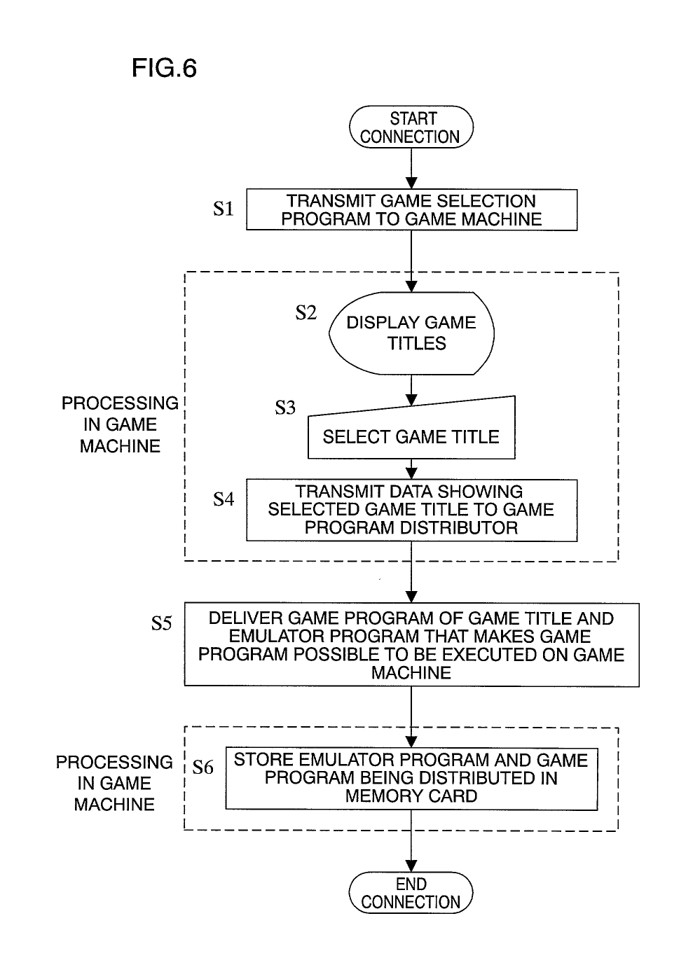

FIG. 6 shows a main routine (general flow) of that embodiment, and in FIG. 6, steps indicated by broken line show the processing on the game machine 20 and other steps show the processing on the delivery apparatus 30.

Operation of the game program delivery system 10 is explained with reference to FIG. 6. Incidentally, the game machine 20 and the delivery apparatus 30 are connected to each other via the Internet utilizing the communication line/link 70 such that the both 20 and 30 can communicate with each other, but connection/disconnection processing and communication processing are not different from ordinary processing in the Internet between a personal computer and a server unit, and therefore, detailed description of the communication protocol is omitted.

In a step (abbreviated as a symbol “S” in the figure) S1, the delivery apparatus 30 reads the game selection program from the storage area 33b of the hard disk 33 based on the main program, if it becomes available for communication with the game machine 20. Then, the game selection program is transmitted to the game machine 20 via the Internet.

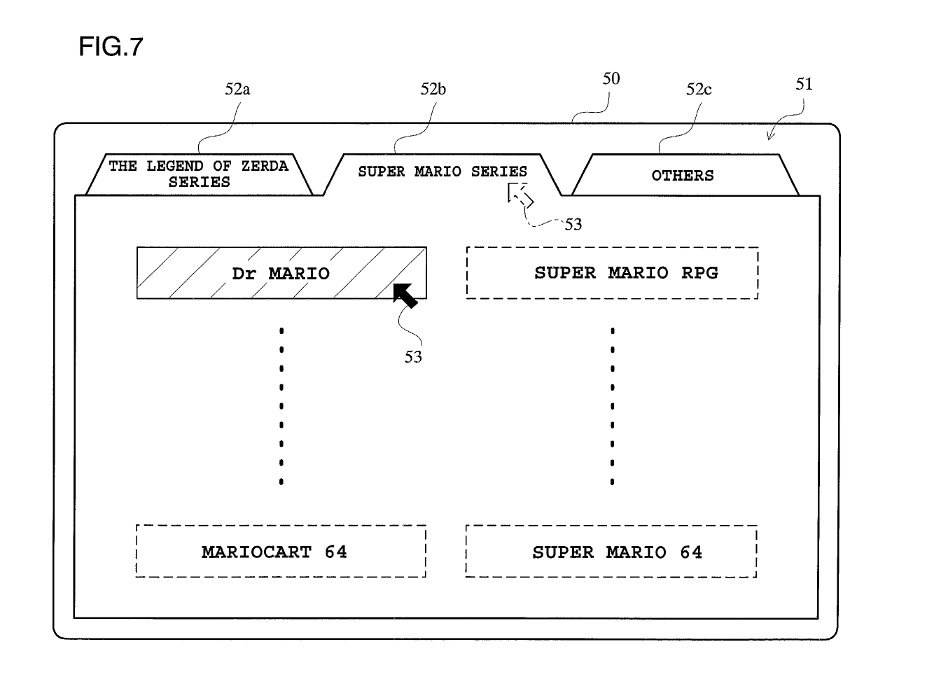

In a step S2, the game machine 20 displays a plurality of game titles by executing the game selection program. Specifically, the game selection program transmitted from the delivery apparatus 30 is first stored in the work RAM 25 (see FIG. 3), thereby executing the menu display/select program. This displays titles of a plurality of ones of game program stored at a side of the delivery apparatus 30 based on the game title list data contained in the game selection program. For example, a game program selection screen 51 is displayed on a display screen of the TV 50, as shown in FIG. 7. The game program selection screen 51 is, preferably, constructed as a plurality of (three in the exemplary embodiment) layered screens 52a-52c separately provided on a series-by-series basis. The layer screens 52a-52c has a tag to select the screen. A series name of game program is displayed on the tag. These game programs in a series may, for example, be game programs for older-generation video game machines (second game machines) different in architecture from and lower in processing speed than the first game machine 20.

In a step S3, a game program selection process is performed. Specifically, a cursor 53 controllable by the game controller 40 is displayed on the game program selection screen 51. The player selects a desired game title by operating the cursor 53 while viewing the menu screen. That is, the player clicks a tag of a desired series name to select an arbitrary series of a layer screen 52a-52c, and then clicks an arbitrary game title of the series to select a desired one of the game programs.

In a step S4, the selected game title is recognized by a delivery instruction program contained in the game selection program, and instruction information causing the delivery of the game program to start is returned to the delivery apparatus 30 together with the data indicative of the game title.

In a step S5, the delivery apparatus 30 delivers to the game machine 20 the game program according to the data returned from the game machine 20 and the emulator program making the game program possible to be executed. Specifically, the CPU 31 receives the returned data and the instruction information for the start of delivery, and stores the same in the memory 32. The CPU 31 searches a game program having a game title according to the data of the game title, and reads the game program from the storage area 33c and the emulator program associated with the game program from the storage area 33d, and thereafter, delivers the emulator program and the game program to the game machine 20.

In a step S6, the game machine 20 stores the emulator program and the game program both delivered by the delivery apparatus 30 in the work RAM 25 and/or the memory card 60. Specifically, the CPU 21 sequentially receives data of the emulator program and the game program being sequentially transmitted from the delivery apparatus 30, thereby to sequentially write the data in the work RAM 25. Then, if the reception of all the program data is completed, the emulator program and the game program being stored in the work RAM 25 are written in the memory card 60, whereby the emulator program and the game program can be stored in the storage area 61 and the storage area 62 in the memory card 60, respectively. If storage capacity of the work RAM 25 is not sufficient, it is possible to store the data being sequentially received on a constant amount basis so as to sequentially write the constant amount data in the memory card 60. In addition, it is possible to store the data in volatile or non-volatile internal memory such as the work RAM 25, etc., without storing in the memory card 60.

After that the emulator program and the game program are stored at a side of the game machine 20, the connection between the delivery apparatus 30 and the game machine 20 is disconnected through an operation of the player. Thereafter, CPU 21 executes the game program based on the emulator program in response to an operation by the player, whereby the older-type-game-machine game can be started.

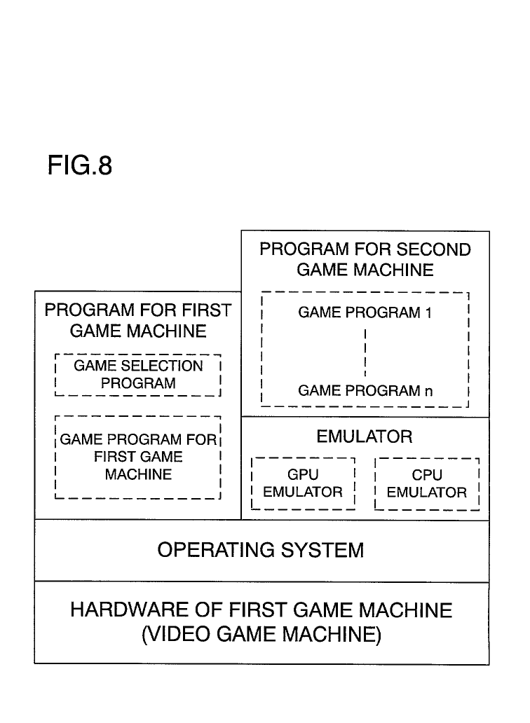

FIG. 8 is an illustrative view of a hierarchical configuration of hardware, an operating system and various programs. An exemplary relationship between the emulator program and the game machine 20 will be described with reference to FIG. 8. An operating system program is executed on the hardware of the video game machine 20 (first game machine). When the DVD-ROM is loaded in the DVD drive 29, a game program for the game machine 20 is read from the DVD-ROM to be processed using the operating system program (or by the CPU 21 through the operating system program).

When the memory card 60 in which the game program for the older-type game machine (second game machine) is loaded to the memory card connection port 28, the game program in the memory card 60 is executed. In this case, since the game program is the game program for older-type game machine having an architecture different from the architecture of the game machine 20 and a lower processing ability, it is impossible to directly execute the game program on the operating system of the game machine 20. Then, in the game machine 20, in order to make the older-type-game-machine game program possible to be processed, the emulator program emulating the older-type game machine is run on the operating system, thereby to execute the second-game-machine game program on the emulator.

The relationship between the video game machine 20 (superior machine or newer-type machine) as the first game machine and the older-type game machine (not shown) which is the second game machine or the inferior game machine will now be explained. These machines are not compatible with respect to their hardware because of differences in architectures adopted. For example, if the CPU of the older-type game machine is an 8-bit machine, a 16-bit machine or a 32-bit machine, the CPU 21 of the newer-type game machine 20 has 64 bits or more that is far higher in capability and/or processing speed. In this case, the older-type-game-machine game program different in architecture can not be processed on the game machine 20 because the kind of executable instruction (machine language) is in nature different between the CPU 21 of the game machine 20 and the CPU of the older-type game machine. An emulator program is employed to convert the instructions of the game program for the older-type-game-machine into the instructions of the game program for the game machine 20. In a case that the older-type game machine comprises the CPU and the GPU, for example, the emulator program preferably includes a CPU emulator program for emulating the operational processing in the CPU and a GPU emulator for emulating the graphics processing in the GPU. Explaining one example of the video game machines marketed by the applicants' assignee, the older-type game machine (second game machine) is one of the 8-bit FAMILY COMPUTER (i.e., the NES), GAMEBOY, 16-bit SUPER FAMICOM (i.e., the SNES) and 64-bit NINTENDO 64 (all trademarks), and the game machine (first game machine) 20 is a newer-type or superior game machine having a processing ability more than that of NINTENDO 64 and an architecture different form that of the older-type game machine.

Next, specific processing in the game machine 20 in executing the older-type-game-machine game program will be described. At a time that the memory card 60 is loaded to the game machine 20, the emulator program is read from the memory card 60, and the emulator program is written in the work RAM 25. The CPU 21 sequentially reads from the memory card 60 and executes the game program based on the emulator program, whereby the game based on that game program can be played by the player on the game machine 20.

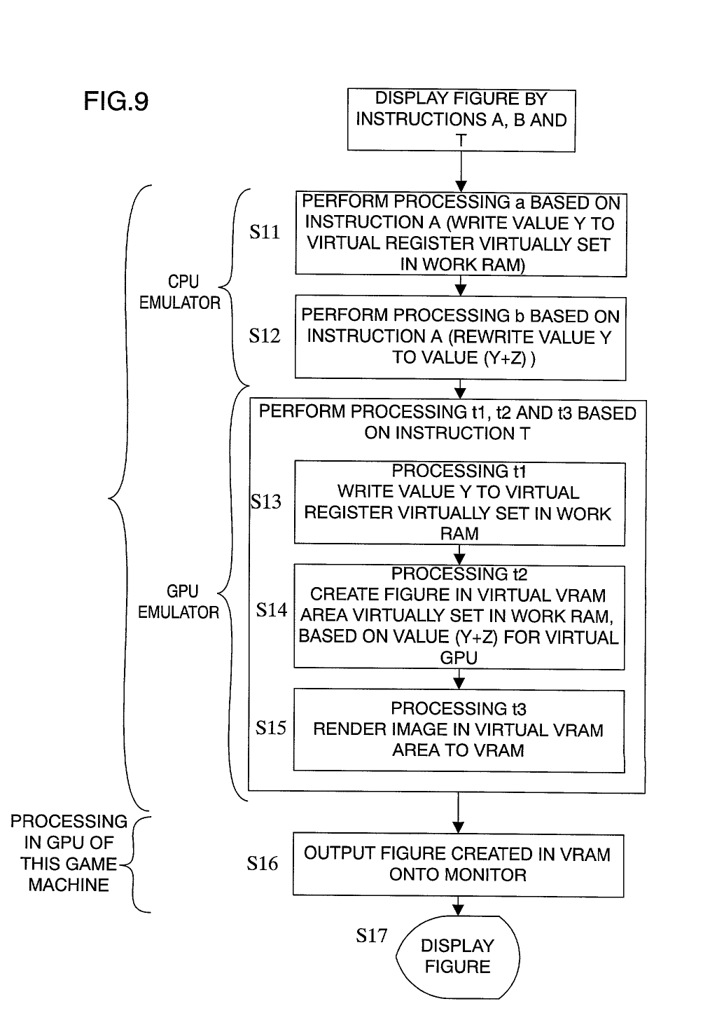

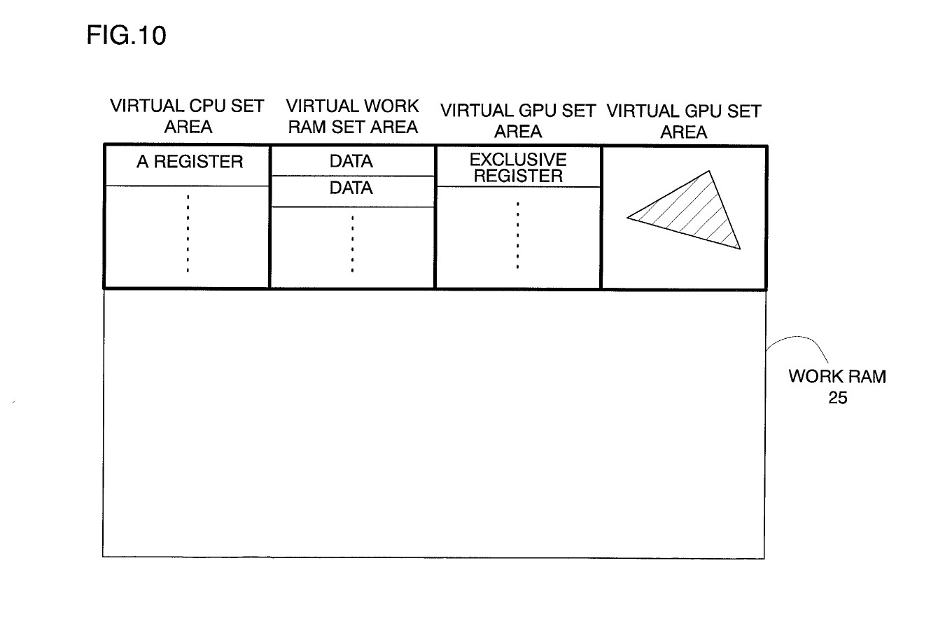

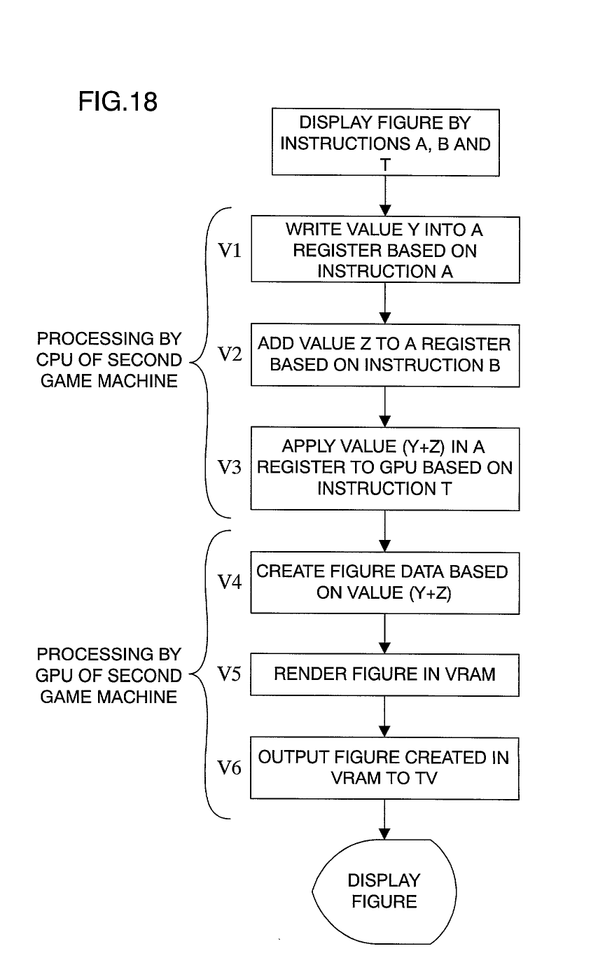

Now, explanation will be made in further detail of the processing of the second-game-machine program to be executed by referring to the emulator program, with reference to FIG. 9. In order to facilitate an understanding of the processing, explanation is made by relating the processing of the CPU and GPU of the conventional second game machine shown in FIG. 18 to the processing by the emulator program of the invention. In the conventional system, when displaying a figure such as a game character, as shown in FIG. 18, object or the like by the second game machine, the CPU of the second game machine has executed instructions A, B (VI-V3) and thereafter the GPU has executed processing (V4-V6) based on an instruction T. It is herein assumed for the CPU of the second game machine that the instruction A is an instruction to write a value Y to an A register of the CPU, the instruction B is an instruction to add a value Z to the A register of the CPU, and the instruction T is an instruction to cause the GPU of the second game machine to perform processing of before displaying a figure based on a value of the A register.

The emulator program allocates, in the work RAM 25 of the video game machine 20, a virtually setting area to virtually reproduce for the CPU and GPU (second processing means) of the second game machine or the work RAM and VRAM included in the second game machine. For example, a virtual CPU setting area is allocated, in a predetermined address, a virtual register, etc. corresponding to each register incorporated in the CPU of the second game machine. Due to this, a virtual A register corresponding to a particular register (A register in one example) of the CPU of the second game machine is set in a particular address of a storage area in the work RAM 25. When there is a processing to the A register of the CPU of the second game machine, the CPU 21 accesses the virtual A register in the predetermined address set in the work RAM 25 thereby emulating the function of the CPU and GPU of the second game machine. Emulation is similarly made for the second game machine GPU, work RAM, V-RAM and so on.

First, in a step S 11, in order to execute a program to display a figure, the emulator program reads out an instruction A constituting the program and performs processing a corresponding to the instruction A. Specifically, the emulator program (CPU emulator) writes a value Y to a virtual A register having a particular address allocated in the work RAM 25 and corresponding to the A register of the CPU of the second game machine. This processing a is executed by instructions a1, a2 and a3 executable directly by the CPU 21.

In a succeeding step S12, an instruction B is read out and the corresponding processing b is carried out. Specifically, the CPU 21 reads out the value Y stored in the virtual A register calculates a value (Y+Z) as a value Y added with a value Z. Then, the value (Y+Z) is written again to the virtual A register.

Furthermore, in steps S13, S14 and S15, an instruction T is read out and the processing t1, t2 and t3 corresponding to the instruction T are made in the order. This instruction T is to cause the CPU of the second game machine to deliver a value of the A register to the GPU of the second game machine so that the GPU can makes processing to render a figure.

Specifically, the CPU 21 makes the following processing based on the GPU emulator program. That is, the processing t1 is first executed to thereby read a value (Y+Z) out of the virtual A register of the work RAM 25. The value (Y+Z) is written to an exclusive register in the virtual GPU setting area. Next, the processing t2 is executed to thereby perform operation processing, e.g. geometry operation, based on the value (Y+Z) written on the exclusive register. Due to this, figure data is produced in the virtual VRAM area corresponding to the VRAM of the second game machine. Furthermore, the processing t3 is executed to thereby produce a figure in the V-RAM 26 based on the figure data in the virtual VRAM area. Then, the CPU 21 instructs the GPU to render the figure. The GPU 22 produces an image based on the figure in the V-RAM and outputs the image data onto a television (step S16). The above processing by the video game machine 20 provides, on the television 50, display of a game picture nearly same as a game picture to be displayed by a game program for the second game machine (step S 17). If there is input through the game controller 40, the instructions for the second-game-machine game program are sequentially read out to sequentially execute the process corresponding to the instructions. In this manner, the game program for the second game machine is made executable by the video game machine 20 having a different architecture.

This makes it possible to easily play a game program for the older-type game machine delivered by utilizing the Internet of the like on the game machine 20. Furthermore, since the older-type-game-machine game program is relatively small in comparison with the newer-type-game-machine game program, even if delivered through the communication line 70, the older-type-game-machine game program can be received in relatively short time. Also, since it is not necessary to change the older-type-game-machine game program to one for the game machine 20, there is an advantage of providing user game programs at low cost. In addition, there is an advantage that the game software makers can obtain further compensation by the delivery of the older-game-machine game programs.

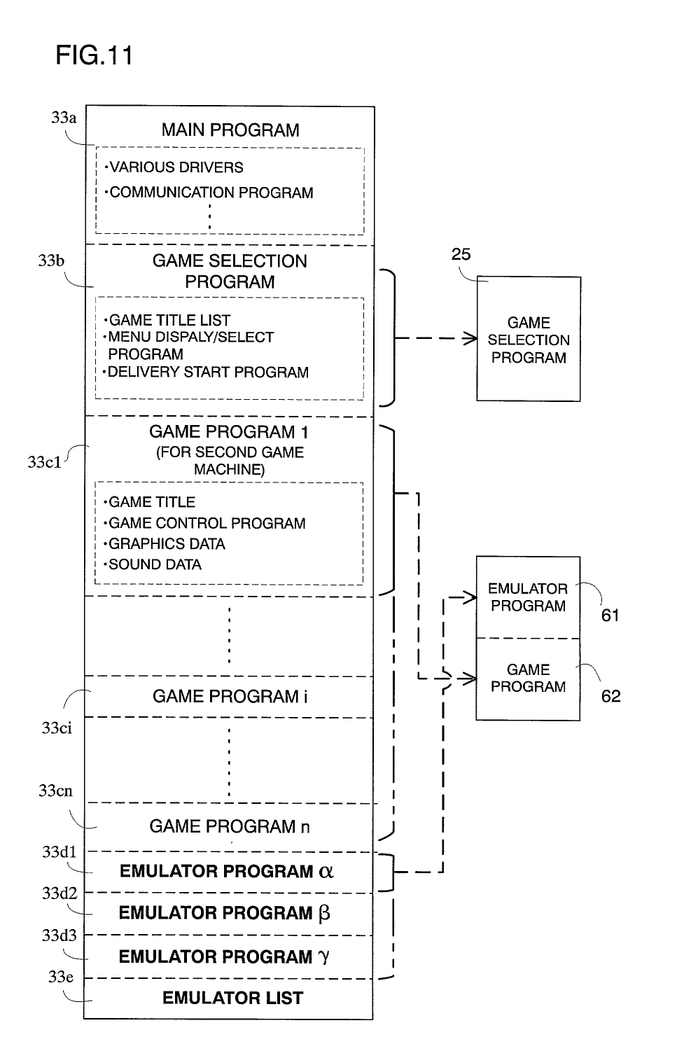

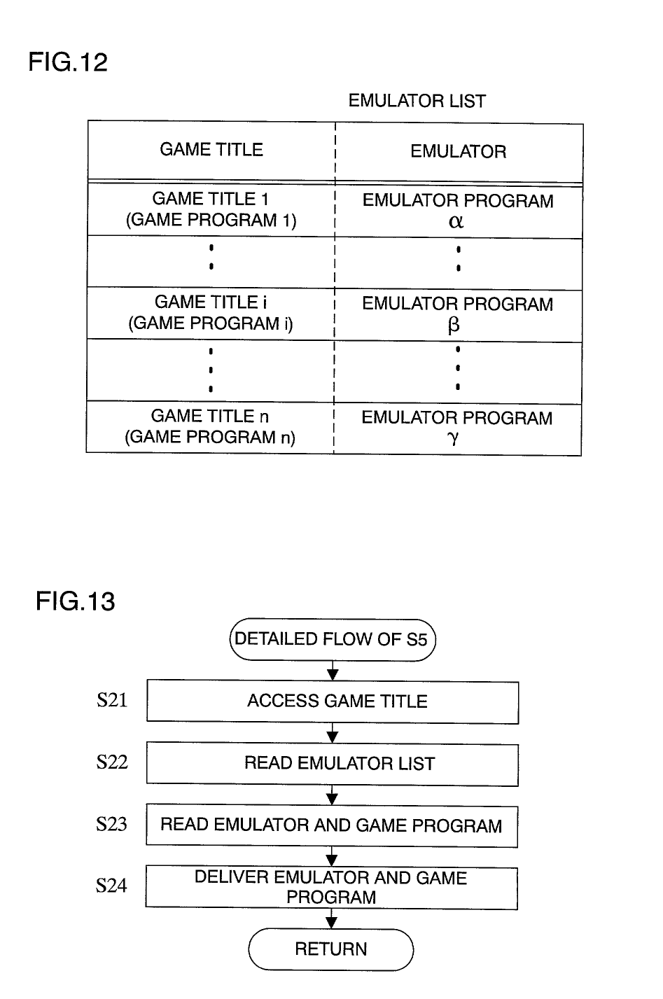

FIG. 11 illustrates storage data on the hard disk 33 of the delivery apparatus 30 according to a second embodiment, FIG. 12 is a figure showing an outline of the emulator list data, and FIG. 13 is a modified flowchart showing the step S5 described above. The second embodiment is different from the first embodiment (FIG. 3) in that the hard disk 33 stores a plurality of game programs (game 1 to game n) to be applied to any of at least of two kinds of inferior, second game machines (not shown) and at least two emulator program (in this modified embodiment, three kinds emulator programs •, • and •). By way of example, the video game machine marketed by the applicant, game programs applied for two kinds of game machines out of an 8-bit machine, a 16-bit machine and a 64-bit machine are stored, and emulator programs in the number dependent upon the number of the inferior machine models (at least two kinds of • and •,• is an emulator to convert 16-bit one into 128-bit one and • is an emulator to convert 64-bit one into 128-bit one) to convert the instructions of the game program for at least two kinds of game machines.

Specifically, the hard disk 33 further has storage areas 33d1-33d3 and 33e as shown in FIG. 11. In the storage areas 33d1-33d3, the emulator programs •,• and • are stored, respectively. Furthermore, the emulator list data by which the game programs of the game titles are associated with the emulators •, • and • is stored in the storage area 33e as shown in FIG. 12.

Next, a case where the game program is delivered by using the hard disk 33 in which the information or programs as the second embodiment shown in FIG. 11 and FIG. 12 will be described with reference to FIG. 13. The processing in this case can be realized by changing the processing of the step S5 in the FIG. 6 flowchart.

In the steps S3 and S4 as explained above, the specific game title is selected, and when the information of the game title is received by the delivery apparatus 30, in a succeeding step S5, together with the game program of the game title, the emulator program for that game program is delivered.

Specifically, as shown in FIG. 13, in a step S21, the CPU 31 of the delivery apparatus 30 fetches the data of the game title contained in the received data, and accesses the game title. Then, in a step S22, the CPU 31 reads the emulator list data stored in the storage area 33e of the hard disk 33 to refer to correspondence relationship between the game title and the emulator program, whereby the emulator program for the game program of the game title selected at a side of the game machine 20 can be grasped. Furthermore, in a step S23, the CPU 31 reads the game program of the game title and the emulator program from the storage areas, and performs preparation for the delivery by storing the programs in the memory 32. Lastly, in a step S24, the CPU 31 delivers the emulator program and the game program both being stored in the memory 32 to the game machine 20. According to these processing, the game machine 20 can receive the game program of the game title that the player selected together with the emulator program making the game program possible to be executed.

In the case a player selects for example a game title i, in step S21 is grasped a game program kind of the game title i. In the succeeding step S22, the emulator program • which makes the game program I possible to be executed is selected. Then, in the step S23, the game program I and the emulator program • are read from the hard disk 33, and the same is delivered toward the game machine in the step S24. Thereafter, processing similar to the above-mentioned step S6 is performed. In this manner, according to processing in steps S1, -S4 and S6, the older-type-game-machine game program of the game title that the player selected is delivered to the game machine 20, and thus, it possible to play on the video game machine 20 a older-type game-machine game program selected for a plurality of kinds of second game machines different in architecture from the video game machine 20.

This makes it possible to play a series of game programs developed for the 8-bit machine, the 16-bit machine and the 64-bit machine (second game machine) different in architecture (e.g. Super Mario 1, 2 and 3 for the 8-bit machine, Super Mario World for the 16-bit machine, and Super Mario 64 for the 64-bit machine: all the trademarks) on a single kind of game machine 20 (first game machine). That is, it is possible to increase the number of the kinds of the game titles capable of being delivered to the single kind of the game machine, it is possible to increase the utility value of the game delivery system introduced in a system including the stand-alone or portable game machines. Furthermore, the series of game program for different models can be played on the single game machine, and therefore, the player can remember game rules in order while enjoying older series games having been released earlier. Thus, it is possible to prevent the feeling of a sudden rise in difficulty level by providing games which players are familiar as compared to the case of immediately playing games for the newest game machine, providing merits of enhancing stepwise the difficulty level, the game clear rate for all of the series and satisfaction by the player.

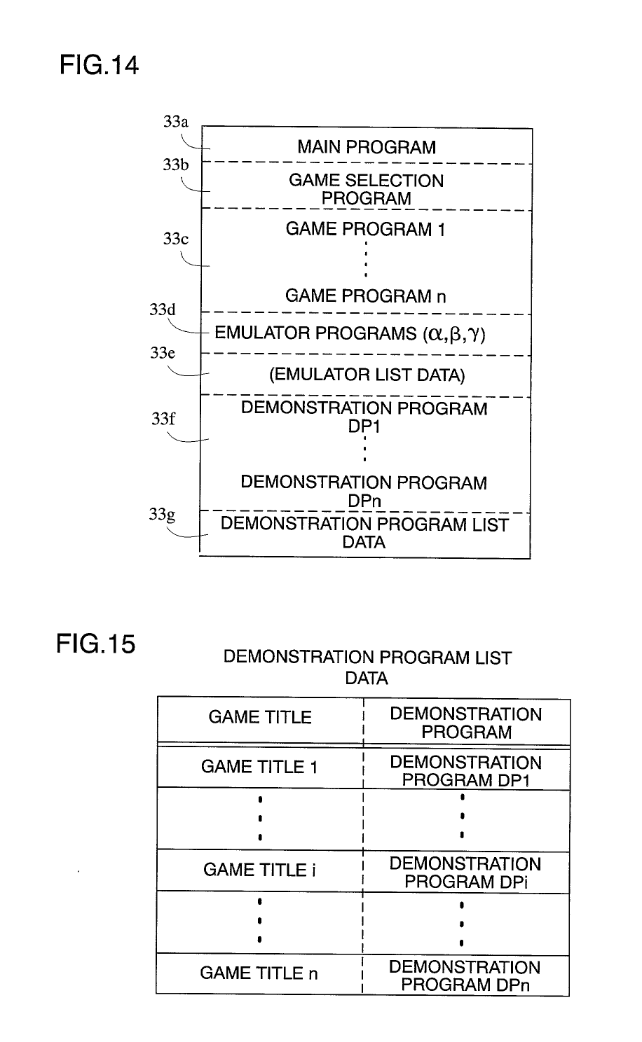

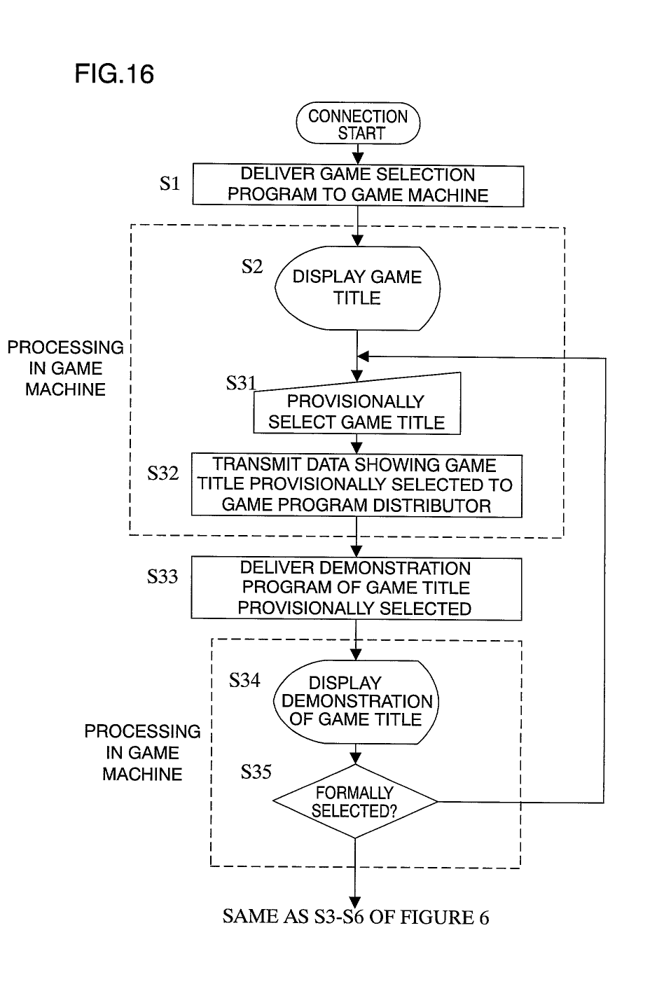

FIG. 14 is a figure illustratively showing storage data on the hard disk 33 of the delivery apparatus 30 according to the third embodiment, and FIG. 15 is an illustrative view showing the details of demonstration program list data. In different from the above-described embodiments, the third embodiment outputs the information of the outline of the game title in selecting the game tile by the player. In this embodiment shown, in order to output the preparatory information showing the game outline, a case that the demonstration is displayed by an animation will be described. Incidentally, portions in brackets in FIG. 14 show the second embodiment, and the other portions show the first embodiment.

Specifically, as shown in FIG. 15, the hard disk 33 further has storage areas 33f and 33g. In the storage area 33f, demonstration programs DP1-DPn are stored, and in the storage area 33g, demonstration program list data is stored. The demonstration program DP1-DPn is a program for displaying on the TV 50 connected to the game machine 20 an animation of at least a portion of the game according to the game title 1-n. Furthermore, the demonstration program list data is data in which the demonstration programs DP1-DPn are respectively associated with the game titles 1-n as shown in FIG. 15.

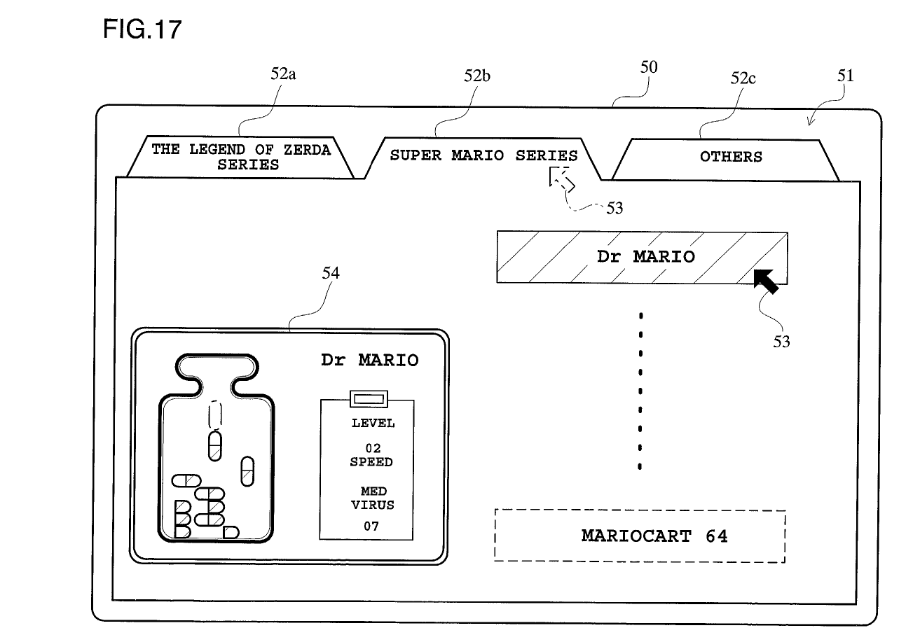

FIG. 16 is a flowchart for explanation of the operation of the third embodiment of the game program delivery system, and FIG. 17 is a figure showing a display screen displayed in the third embodiment. Next, explanation is made on the operation of this embodiment with reference to FIG. 16 and FIG. 17. In FIG. 18 duplicated portions with those of the flowcharts having been previously explained are given the same symbols, omitting explanations thereof.

As shown in FIG. 16, by the processing in the steps S1 and S2, the game title is displayed on the TV 50. In order to grasp of the game outline of a desired game title, the player provisionally selects the game title (for example, single-click). In response to the provisional selection thus made, processing of the steps S31 and S32 are performed, and therefore, the animation of the game title that is provisionally selected is displayed on the TV 50 as the demonstration. Then, the player who grasped the desired game title through the animation formally selects the game title (for example, double-click). In response to the formal selection, the processing of the steps S3-S6 in FIG. 6 are performed. On the other hand, if the player grasped that the game title is non-desired game title through the animation, further provisionally selects other game title. During such the provisional selection, steps S31-S34 are repeated.

Specifically, in the step S2, as shown in FIG. 17, the game selection screen 51 is displayed, on the TV 50 and the cursor 53 is displayed on the screen. Incidentally, at this time, the demonstration screen 54 has not been displayed.

In step S31, the player provisionally selects (for example, single-click) the desired game title, for example, “Dr. Mario”: hereinafter, “game title i” by the cursor 53, in response to this, in the step S32, the game selection program executed by the CPU 21 of the game machine 20 detects that the provisional selection was made, and transmits the data representing that the game title I is provisionally selected to the delivery apparatus 30.

In the step 33, the CPU of the delivery apparatus 30 grasps the game title I included in the transmitted data and that the game title i is provisionally selected, references to the demonstration program list data stored in the storage area 33g of the hard disk 33. According to this list data, the CPU 31 reads the demonstration program DPi, for example corresponding to the provisionally-selected game title I from the storage area 33f, and delivers the demonstration program Dpi to the game machine 20.

In the step S34, the CPU 21 of the machine 20 executes the demonstration program DPi received from the delivery apparatus 30, and by executing the demonstration program DPi, the demonstration screen 54 shown in FIG. 17 is set on the game selection screen 51, and the demonstration animation of the game of the game title “Dr. Mario (trademark)” is displayed on the demonstration screen 54.

In a step S35, the player recognizes the animation displayed on the demonstration screen 54, and if the game is one that the player desires, formally selects the game title (for example, double-click) by the cursor 53. The game selection program detects the game title is formally selected, and then, executes the processing similar to the steps S3-S6, the emulator program and the player-desired game program are delivered to the game machine 20. On the other hand, when the provisional selection is made again in the step S34, the steps S31-S34 are repeated.

By doing so, the player can grasp the outline of the game for the second-game-machine game program, and therefore, it becomes for the player possible to be delivered the desired game more quickly and more surely. That is, there is advantage that it is possible to prevent the selection error that the player knew the selected game title is not of desired game after the delivery is received, and therefore, there is merits it is possible to decrease the buying cost of the delivery game program.

In addition, in the third embodiment, a case that as the preliminary information showing the game outline, the animation is displayed for the demonstration of the game was described, but as other preliminary information, a still picture in the game may be displayed, or a comment sentence explaining the outline of the game may be displayed. That is, by transmitting a program including the text data of the comment or the image data of the still picture to the game machine 20 instead of the demonstration program, such the program can be executed by the CPU 21 of the game machine 20. Thus, in the demonstration screen 54 of the game selection screen 51 displayed on the TV 50 connected to the game machine 20, instead of the animation, the comment sentence or the still picture can be displayed. If the comment sentence is utilized, it is possible to grasp the game outline in more detail, and if the still picture is utilized, the game outline can be grasped quickly with short time.

Furthermore, instead of the animation, it is possible to output a sound from the speaker (not shown) of the TV 50. More specifically, instead of the demonstration program, a program including the sound data is executed, whereby the outline of the game is generated from the speaker of the TV 50 in sound. In this case, there is advantage that it makes the player more easily grasp the game outline by the sound.

Furthermore, the above embodiment was explained for the case, as an applicable example of the invention, that the game program for the older-generation game machine manufactured/marketed by the applicant is to be used on the next-generation game machine 20. However, it is pointed out that the invention is not limited to applications between the older-generation and next-generation game machines of the applicants' assignee but is applicable to a wide range of game machines of other manufacturers.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A game program delivery system for delivering a game program from a game program delivery apparatus to a first game machine having a first architecture through a bidirectional information delivery medium, comprising:
game program delivery apparatus having a program store and a processor for performing game program delivery processing operations,
said program store storing:
at least one game program for a second game machine employing a second architecture different from the first architecture of the first game machine,
at least one emulator program for enable the game program for the second game machine to be executed on the first game machine by emulating the second game machine, and
a game selection program for displaying game title related information relating to the game program on a display screen of the first game machine to provide for game program selection by the player, and
wherein said processor for performing game program delivery processing operations is operable to transmit the game selection program to the first game machine through the bidirectional information delivery medium so that the game selection program can be executed on the first game machine to allow for selecting a game title, and to deliver an emulator program together with the game program corresponding to the selected game title related information to execute the selected game program on the first game machine, and
wherein said first game machine includes:
a game program processing system for executing the game selection program sent through the bidirectional information delivery medium and to display game title related information on a display screen,
a program selector for selecting a game title based upon information displayed on the display screen, and
a delivery-data store for storing at least one of data and programs delivered from the game program delivery apparatus, whereby
the game program delivery system allows the game program processing system of the first game machine to execute a game program based on the emulator program delivered from the game program delivery apparatus, thereby enabling game play in accordance with the game program for the second game machine on the first game machine.

2. A game program delivery system according to claim 1, wherein the game program delivered includes a plurality of game programs for the second game machine having at least two kinds of architectures different from that of the first game machine, and
the emulator program includes at least two emulator programs to emulate the second game machine having at least two kinds of architectures, respectively.

3. A game program delivery system according to claim 1, wherein the game selection program includes a program for a player to provisionally select in order for accessing information regarding a desired game title, and a program to formally select a desired game title to be delivered to the first game machine, and
wherein the program store stores a preparatory program which, when a desired game title is provisionally selected by the player, outputs, on the first game machine, preparatory game information representative of at least a portion of the outline of a game to be offered by a game program of that game title, and
wherein the processor for performing game program delivery processing operations is operable such that
when a desired game title is provisionally selected by the player and the information representative of the selected game title is sent back, delivers a preparatory program to the first game machine,
when a desired game title is formally selected by the player and the information representative of the selected game title is sent back, delivers a game program of that game title together with an emulator program for executing the game program on the first game machine to the first game machine.

4. A game program delivery system according to claim 3, wherein the preparatory program is a program to demonstrate a game outline by animation.

5. A game program delivery system according to claim 3, wherein the preparatory program is a program to display a game outline by still images.

6. A game program delivery system according to claim 3, wherein the preparatory program is a program to display text explaining a game outline.

7. A game program delivery system according to claim 3, wherein the preparatory program is a program to generate a sound-based-output explanation of a game outline.

8. A game program delivery system according to claim 1, wherein the second game machine has a lesser processing capability than the first game machine.

9. A game program delivery apparatus for delivering a game program through the bidirectional information delivery medium to a first game machine employing a first architecture, comprising:
a program store and processor for performing game program delivery processing operations, wherein
the program store stores:
at least one game program for a second game machine employing a second architecture different from the first architecture of the first game machine,
at least one emulator program for executing a game program for the second game machine on the first game machine by emulating the second game machine, and
a game selection program permitting the player to select on the first-game-machine display screen game title related information, and wherein
the processor for performing game program delivery processing operations transmits the game selection program through the bidirectional information delivery medium to the first game machine so that the game selection program can be executed on the first game machine to allow for selecting a game title, and delivers together with a game program an emulator program for permitting the game program to be executed on the first game machine when information indicative of the selected game title is sent back through the bidirectional information delivery medium.

10. A game program delivery apparatus according to claim 9, wherein the game program includes a plurality of game programs for the second game machine having at least two kinds of architectures different from that of the first game machine, and
the emulator program includes at least two emulator programs to emulate the second game machine having at least two kinds of architectures.

11. A game program delivery apparatus according to claim 9, wherein the game selection program includes a program for a player to provisionally select in order for accessing information regarding a desired game title, and a program to formally select a desired game title to be delivered to the first game machine, and
wherein the program store stores a preparatory program which, when a desired game title is provisionally selected by the player, outputs, on the first game machine, preparatory game information representative of at least a portion of the outline of a game to be offered by a game program of that game title, and
wherein the processor for performing game program delivery processing operations is operable such that
when a desired game title is provisionally selected by the player and the information representative of the selected game title is sent back, delivers a preparatory program to the first game machine,
when a desired game title is formally selected by the player and the information representative of the selected game title is sent back, delivers a game program of that game title together with an emulator program for executing the game program on the first game machine to the first game machine.

12. A game program delivery system according to claim 9, wherein the second game machine has a lesser processing capability than the first game machine.

13. A method for delivering game programs over a communication network to a first game machine having a first architecture comprising the steps of:
transmitting a game selection program to said first game machine;
displaying on a display associated with said first game machine information indicative of a plurality of game titles,
delivering to said first game machine via a communications link, in response to the selection of a game, a game program designed for execution on a game machine having an architecture which is different from said first architecture and an emulator program for enabling execution of the selected game program on said first game machine; and
storing data indicative of said game program and said emulator program in a memory in said first game machine to enable subsequent game play of the video game associated with said game program on said first game machine.

14. A method according to claim 13, wherein said displaying step includes the step of displaying a plurality of game titles.

15. A method according to claim 13, wherein said displaying step includes the step of displaying information indicative of a plurality of game titles transmitted via said game selection program.

16. A method according to claim 13, wherein said displaying step includes the step of displaying a layered series of display screens, wherein each layer includes a tag for user selection.

17. A method according to claim 13, wherein said displaying step includes the step of displaying information indicative of a related series of games.

18. A method according to claim 17, wherein said step of displaying information indicative of a related series of games includes the step of displaying information indicative of a first game executable by a processor having a first processing capability and involving a first character and displaying information indicative of a second game executable by a processor having a second processing capability greater than said first processing capability and also involving said first character.

19. A method according to claim 13, further including the step of selecting a game by said first machine by responding to a player's manipulation of a player controller.

20. A method according to claim 13, wherein said storing step includes the step of storing in a memory card associated with said first machine at least one of the received game program and the associated emulator program.

21. A method according to claim 13, further including the step of executing said emulator program at said first machine to enable the game program designed for a second game machine to be executed on the first game machine by emulating the second game machine.

22. A method according to claim 13, wherein the game program delivered includes a plurality of game programs for a second game machine having at least two kinds of architectures different from that of the first game machine, and
the emulator program includes at least two emulator programs to emulate the second game machine having at least two kinds of architectures.

23. A method according to claim 13, further including the steps of permitting a player to provisionally select a desired game title in order to access information regarding a desired game title, and then to formally select a desired game title to be delivered to the first game machine.

24. A method according to claim 23, further including the steps of storing, a preparatory program which, when a desired game title is provisionally selected by the player, outputs, on the first game machine, preparatory game information representative of at least a portion of the outline of a game to be offered by a game program of that game title.

25. A method system according to claim 13, further including the step of demonstrating on said first machine a game outline by animation.

26. A method system according to claim 13, further including the step of demonstrating on said first machine a game outline by still images.

27. A method system according to claim 13, further including the step of demonstrating on said first machine a game outline using displayed text.

28. A method system according to claim 13, further including the step of demonstrating on said first machine using a sound-based-output explanation of a game outline.
